(19) United States
(12) Patent Application Publication
(10) Pub. No.: US 2015/0122217 A1
(43) Pub. Date: May 7, 2015

(54) INTERNAL COMBUSTION ENGINE AND METHOD OF DIRECT FUEL INJECTION

(71) Applicant: Transonic Combustion, Inc., Camarillo, CA (US)

(72) Inventors: Wolfgang Bullmer, Camarillo, CA (US); Michael J. Frick, Newbury Park, CA (US); Lutz Lehmann, Ventura, CA (US)

(73) Assignee: Transonic Combustion, Inc., Camarillo, CA (US)

(21) Appl. No.: 14/074,437

(22) Filed: Nov. 7, 2013

(51) Int. Cl. F02B 17/00

(52) U.S. Cl. CPC F02B 17/005
USPC 123/295

(57) ABSTRACT

A direct fuel injection method and an internal combustion engine provided with appropriate sensors and data input lines to an Engine Control Unit (ECU) for performing this method. The method includes inputting at least data inputs representing a piston position, a rotational speed of the internal combustion engine, and a torque demand into an ECU, calculating in the ECU a calculated start of injection (SOI) for the direct fuel injection that is next based on the data inputs, calculating based on the data inputs and the calculated SOI a desired fuel temperature prior to the direct fuel injection that is next, heating fuel with a system delay not to exceed 5 seconds to the desired heated fuel temperature prior to a direct fuel injection, injecting the heated fuel, and repeating the aforementioned method steps for subsequent direct fuel injections.

### TECHNICAL FIELD

The present invention relates generally to internal combustion engines, and more particularly relates to combustion control and improved fuel efficiency and emissions performance for internal combustion engines through controlling fuel temperature prior to injection.

### DESCRIPTION OF THE RELATED ART

Particulate emissions from internal combustion engines depends for a major part on how complete the combustion is since incomplete combustion results particularly in solid carbon particulates. The completeness of the combustion is also related to fuel efficiency and minimizing emission of hazardous gases. Parameters influencing the completeness of the combustion may include engine geometry (B/S), compression ratio, intake air motion tuning (swirl and tumble), combustion chamber geometry, air guided fuel flow, wall guided fuel flow, fuel guided flow, injection timing, injection pressure, multiple shot injection, injector nozzle geometry, etc. A number of these parameters influence how evenly the fuel has been mixed with air in the combustion chamber prior to ignition. Despite the number of available variables, the eventual design of the combustion system frequently leads to compromises in performance. This may limit the potential fuel efficiency, exhaust emissions, combustion noise and other factors.

Solid particulate emissions from internal combustion engines have been identified as a potential health hazard. Diesel engines have been fitted with particulate filters to reduce these emissions. Gasoline engines, particularly those implementing Direct Injection of Gasoline (DI) are now subject to legislation that caps the number of particulates that can be emitted per distance traveled. In an effort to meet the requirements of the legislation without the use of a particulate filter, automakers are investigating advanced fuel injection concepts as well as advanced combustion systems.

Particulate emissions result from incomplete mixing of the fuel and air charge within the combustion chamber of the engine. On DI engines the need to deliver the complete mass of fuel within a limited window of time means that there is often a very dense cloud of fuel particles near the tip of the fuel injector. These particles must then vaporize, or change state from liquid to gas, and then the fuel vapor must be uniformly mixed with air in the combustion chamber. Many methods of improving this mixing, such as through increased air motion, have an adverse effect on the efficiency of the engine. Methods of imparting energy to the incoming air charge, such as tumble or swirl, have the effect of reducing the overall amount of air drawn in during the intake stroke.

Today's DI gasoline engines utilize multiple jets of fuel and high levels of air motion in an attempt to improve the mixing of the air and fuel. Engine manufacturers are now investigating the use of very high pressure fuel (>200 bar) as a means of reducing the size of the particles in the fuel jet. The smaller these particles are, the greater the surface area in relation to the volume of the particle. This increased surface area allows the particle to evaporate more readily. The more quickly the particles evaporate, the more time there is for mixing the fuel vapor with the air and thus the more even the distribution of fuel vapor within the air charge.

Up to a certain pressure the increased pressure means that the particles travel further from the fuel injector tip. In some cases they travel far enough that they hit the surfaces of the combustion chamber, an effect known as “wall and/or piston wetting”. When a fuel droplet hits a chamber wall, it is less likely to evaporate as the wall is often cool. This fuel doesn't burn efficiently and is exhausted as a partially burned hydrocarbon, leading to a smoke particle.

Fuel pressures up to 500 bar and even 1000 bar are being proposed as a means of reducing the size of the fuel particles in the jets. The increased pressure imparts enough energy to the fuel that it vaporizes almost instantly upon leaving the fuel injector, a process known as “flash boiling”. This flash boiling has the effect of generating very quickly a vapor cloud that can be mixed with the air charge. It also limits the distance the fuel travels from the injector tip, minimizing the potential for wall wetting. The energy required to compress gasoline to these very high pressures is significant, however, and may require a power as high as about 15-20 kW or even higher. Due to the high torque that is required for providing this power it must come from the engine either directly or through an alternator in the case of an electrically-driven pump. In either case, the need to compress the fuel to this much higher fuel pressure reduces the efficiency of the engine due to the increased parasitic losses.

From a structural design point of view, providing a pump that is capable of delivering such a high fuel pressure correlating to a high power required by the pump is a challenge both for the pump design as well as for the internal combustion engine design. From a pump perspective, gasoline has a limited ability to lubricate moving parts. Thus, special materials or a complex design of the fuel pump are required to reliably raise the gasoline to these pressures since due to the high power the movable parts within the pump are also subjected to high forces. From an internal combustion engine perspective, fuel pumps that require such a high power and are directly driven by the combustion engine are typically connected through a chain or a belt directly to the crankshaft complicating the allover design of the internal combustion engine since the crankshaft is typically difficult to access in an internal combustion engine for connecting any auxiliaries such as a fuel pump. Alternatives would be to connect the pump to the typically more readily accessible camshaft but that would require a more rigid camshaft design to sustain such a high torque as required by the pump that is capable of delivering the required power. Since camshafts are predominantly designed for actuating valves—which requires only a moderate torque—camshafts typically have a much smaller diameter than what would be required for delivering the desired pump torque. Therefore, either way, whether the pump is driven directly by the crankshaft or by the camshaft, it complicates the internal combustion engine design for various reasons.

From the US patent application published under the publication number US 2013/0081592 A1 it was known that the fuel injection temperature is one of the parameters that determines the location of the fuel cloud. The US patent application publication number 2013/0081592 A1 suggests to control the location of the fuel cloud via a fuel temperature in stratified charge combustion processes, both for spark ignition (SI) and compression ignition (CI). Although this prior art in general recognizes that the fuel temperature has some influence on the combustion process, namely via influencing the location of the fuel cloud, it fails teaching any dynamic control of the fuel temperature. “Dynamic” means in this context that it can change depending on the engine operating conditions. The temperature is influenced in this prior art application by fixed points, not dynamically depending on actual engine operating conditions such as real time or in any correlation to real time.

### SUMMARY OF THE INVENTION

It is an object of the invention to increase the combustion efficiency and therefore to reduce the particulate emission but at the same time to keep the fuel pressure prior to injection at a moderate level.

This and other objects of the invention are achieved according to a first aspect of the invention by a method of direct fuel injection into a cylinder of an internal combustion engine, the method comprising:
a) inputting at least data inputs representing a piston position, a rotational speed of the internal combustion engine, and a torque demand into an Engine Control Unit (ECU);
b) calculating in the Engine Control Unit (ECU) a calculated start of injection (SOI) for the direct fuel injection that is next based on the data inputs;
c) calculating based on the data inputs and the calculated start of injection (SOI) a desired fuel temperature prior to the direct fuel injection that is next;
d) heating fuel with a system delay not to exceed 5 seconds to the desired heated fuel temperature prior to a direct fuel injection;
e) injecting the fuel heated in step d);
f) repeating steps a) to e) for subsequent direct fuel injections.

The aforementioned and other objects of the invention are achieved according to a second aspect of the invention by an internal combustion engine comprising:
at least one cylinder-piston combination with a piston performing a linear movement within the cylinder, the cylinder-piston combination defining a cylinder volume that is connected to a fuel injector;
a crankshaft;
a fuel heater heating fuel in the injector;
a connecting rod connecting the piston to the crankshaft;
a sensor representing a piston position;
a sensor representing the rotational speed of the crankshaft;
a fuel injector temperature sensor sensing the temperature of fuel to be injected;
a torque demand sensor; and
an Engine Control Unit (ECU) comprising at least data input ports for data lines from the sensor representing a piston position; the sensor representing the rotational speed of the crankshaft, the fuel injector temperature, and the torque demand sensor and having at least one data output port connecting to a data line to the fuel heater, wherein the ECU calculates the data output through the data output line at least based on data input from the data input ports.

### DETAILED DESCRIPTION OF THE INVENTION

The method and apparatus according to the invention controls the fuel temperature in order to achieve the greatest degree of homogenization possible, thus reducing the number of smoke particles generated. The invention recognizes that a more complete combustion can be better achieved by a temperature increase. Further, fuel heating can be accomplished much more easily than increasing the fuel pressure both as to the expenses and the design of the engine. The invention recognizes that it would be beneficial for a better vaporization to control the fuel temperature dynamically depending on various variables of the engine operation. For instance, these variables are: i) start of injection (SOI) as calculated in the ECU depending on data inputs, ii) torque demand, iii) rotational speed (can be measured at various rotating component parts within the motor), and iv) compression ratio (CR), and v) piston position that can be determined from the rotational position of the crankshaft or the camshaft. For this purpose, either a sensor that measure directly the piston position, or a sensor measuring a rotational angle of any rotating part within the motor can be used, such as a crank sensor measuring the rotation angle of the crankshaft, or in the alternative any other rotating part like the camshaft or any transmission or clutch part as far as the transmission ratio of that rotating part is known and it does not have any slip with respect to the crankshaft.

While the compression ratio is a constant in many engines, newer developments provide for varying the compression ratio so that this may also be taken into consideration as a variable according to a preferred embodiment.

An alternative to higher fuel pressures is increased fuel temperature. In this case, the temperature of the fuel provides the energy needed to vaporize the fuel. If the injected fuel temperature is hot enough, the fuel may exit the injector in a supercritical state, i.e. a dense vapor. Depending on the conditions within the combustion chamber at the time of injection, this fuel may remain in a vapor state or may condense into particles of a very small size, typically less than 7 micrometers in diameter. In either case, the mixing with the air in the chamber is enhanced due to the rapid vaporization of the fuel. Flash boiling may also occur if the pressure in the combustion chamber is low, as it is on the intake stroke. The mechanism of vaporization and mixing with the air charge is the same as that of very high-pressure injection, but traditional fuel pressures (approximately 150 bar) can be used. The energy added to the fuel is in the form of heat. This heat may be supplied from the waste heat in the exhaust stream, or may be supplied electrically, or may be supplied by a combination of both. When electric heat is used, there are losses in efficiency due to the alternator load, but these losses are lower than those associated with pumping fuel to high pressure.

This invention describes a method of optimizing the mixing of air and fuel through the control of the fuel temperature based on engine operating conditions. The primary inputs to this control are piston position and engine load and speed, as well as compression ratio in engines with variable compression ratio. The engine load can for instance be determined by the torque demand as it is input via the gas pedal position into the ECU and the rotational speed. The gas pedal position is a leading indicator for determining the operational condition of the engine. While the preferred embodiment of this invention envisions a gasoline spark-ignited engine, this invention works equally well in a compression-ignited engine.

Measurements of particulate emissions and fuel consumption made on spark-ignited engines have shown that there is an optimum temperature for the injected fuel that varies based on the engine speed and the amount of power being generated. While the relationship of fuel temperature versus the engine speed and load is unique to each engine, this relationship can be easily determined as part of the engine calibration process. The value of the optimum temperature at each point can be stored within the Engine Control Unit (ECU) as a table, or as an equation with speed and load as the independent variables.

In DI engines there is an optimum point in the cycle at which to inject the fuel. This optimum is determined by mixing rates, knock resistance strategy, and fuel penetration control. The time available for mixing varies as the timing of the start of injection varies. When the fuel is injected early in the intake stroke, for example, suitable reduction in particulate emissions may be accomplished with less heat input to the fuel than when the fuel is injected in the compression stroke. In practice, the temperature of the fuel is increased as the start of injection occurs later in the intake or compression stroke. The temperature is reduced as compression ratio increases in order to prevent the occurrence of pre-ignition, or knock.

Thus, in a test engine, the desired fuel temperature prior to injection can be described as the following function:

T_{f}=f(SOI,BMEP,rpm,CR)

where T_{f} is the fuel temperature, SOI is the Start Of Injection, BMEP is the Brake Mean Effective Pressure, or engine load, rpm is the engine speed and CR is the actual engine compression ratio that is a variable for engines with an adjustable compression ratio but a constant in engines with a non-adjustable compression ratio.

It should be understood that the start of injection SOI is not measured directly, but is calculated in the ECU depending on various inputs, for instance an input of the piston position as it can be determined by the angular position of the crankshaft or camshaft. Since this sensor determining the crankshaft or camshaft position essentially measures a rotational angle, it may as well be used for measuring the rotational speed rpm of the engine.

The preferred implementation of the hardware of this system consists of a fuel preheater which brings the fuel to a certain minimum temperature, typically the lowest needed by the engine. This preheater may use exhaust gas to heat the fuel through a heat exchanger, or may use a resistive electric heater. The fuel injector contains an electric heater which is used to bring the fuel temperature from its minimum value up to the temperature needed at the current operation point. The heater in the fuel injector has a low thermal mass so that the fuel temperature can accurately follow changes in engine load. The desired temperature for the fuel to be injected in a specific cycle can be accomplished by very short delays, for instance lagging by just 1-3 cycles and this delay can of course be further taken into consideration by a fuel injection cycles lookahead calculation. While a one cycle lookahead at an engine rotational speed of typically a few thousand revolutions per minute (rpm) is only a small fraction of a second, a significant performance increase can also be obtained with much longer delay times, such as up to 5 seconds, preferably 1-2 seconds, and this can be easily accomplished for the fuel in the fuel injector. Depending on the type of vehicle, for instance a truck provided for long distance use, even longer delay times than 5 seconds can be beneficial. For instance, for a vehicle typically driving for hours under almost constant engine operating conditions like a truck in commercial long distance use, a delay time going beyond 5 seconds would obviously still accomplish the goals of the invention. Although the heaters are typically provided within the fuel injector and therefore have a very small mass, it needs to be understood that even a low mass causes some minor delay so that the fuel temperature does not respond immediately on a signal sent to the fuel injector heater. However, a response of the heater upon receiving a signal from the ECU down to response times between 1 and 3 cycles can be accomplished with respective design efforts.

The heater in the injector is controlled by the ECU through control of the electric current to the heater. This electric current is determined through the equation above. Feedback of the injector heater temperature to the ECU is accomplished through the use of a temperature sensor at the injector. In an alternative embodiment, this feedback may be accomplished through the use of the heater itself as a temperature sensor by measuring the resistance of the heater. In another embodiment, the feedback may take place through the use of a model within the ECU of the injector whereby fuel flow and heater currents are the input to the model and fuel temperature is the output.

In the calibration process a map is generated where the individual variables are prioritized. For example, if the engine's knocking limit is reached this takes priority over other variables for optimizing the temperature. The next variable that probably takes priority over the other variables is the start of injection (SOI). As a rule of thumb, the later in time the injection is made the higher the fuel temperature needs to be for accomplishing a complete evaporation. Supercritical injection is also an option. A further increase of the temperature beyond the point of supercritical condition does not improve the evaporation significantly further. The next two variables in the priority ranking are torque demand and rotational speed with torque demand being more important than the rotational speed. The map can be substituted by a model that needs to be tuned in the calibration process. The model can make the decision process of prioritizing the influence of variables on the fuel temperature. The model can be generated from empirically determined data that are converted into a formula by known mathematical transformation methods such as Fourier or Laplace transformations. Once stored in the ECU, the desired fuel temperature for injection can be calculated based on this formula and input of the variables as described above. Upon such calculation, either based on a formula or a map, the ECU now has to generate a command output signal for the heater output power based on the difference between desired temperature and actual temperature.

Although the invention is also applicable for injection ignited internal combustion engines, the preferred embodiment of this patent is a fuel system for a Spark-Ignited (SI) gasoline internal combustion engine. Heating of the fuel is performed under control of the ECU by means of an electric heater within the fuel injector. This fuel injector is capable of injecting the fuel under supercritical conditions.

An alternative embodiment utilizes a fuel preheater to minimize energy consumption inside the injector. An overall optimized system uses waste exhaust energy to preheat the fuel.

A preferred embodiment may be implemented by sensing the fuel temperature of the fuel heated in step d) and inputting data representing the fuel temperature into the Engine Control Unit (ECU) for providing a closed loop control of that fuel temperature. In the alternative, it would also be possible to control the injector heater by an open loop control since the properties of the fuel injector itself are not variables but constants and the fuel temperature is the result of the heater power that could be controlled by an open loop control.

A preferred embodiment may be implemented by sensing the piston position and the rotational speed of the internal combustion engine by a sensor provided at at least one of a crankshaft and a camshaft of the internal combustion engine. Although both the crankshaft or camshaft angular positions as well as their rotational speed can be sensed with one and the same sensor, it would also be possible to use different sense source and measure at different elements, for instance the rotational speed by measuring at a rotating element in the transmission in combination with a known transmission ratio.

A preferred embodiment may be implemented by calculating in the Engine Control Unit (ECU) for an internal combustion engine having a variable compression ratio based on the data inputs in step a) a desired compression ratio for the direct fuel injection that is next; calculating based on the data inputs, the start of injection (SOI) calculated in step b), and the calculated compression ratio a desired fuel temperature prior to the direct fuel injection that is next; and commencing with steps d) to f) based on that desired fuel temperature. The fuel injection that is next is determined by the ECU that may calculate ideal date for the immediate next fuel injection cycle. However, the system does of course like all systems in the real world have a minor delay time for a response on a control signal. Further, no 100% real-time adjustment needs to be made to the fuel temperature for achieving most part of the desired effect. In addition, according to a preferred embodiment, a lookahead calculation can be made that takes some of the delay time into account.

A preferred embodiment may be implemented by adjusting the variable compression by a compression adjusting mechanism; sensing the actual compression ratio and inputting data representing the actual compression ratio into the Engine Control Unit (ECU) for providing a closed loop control of that actual compression ratio; inputting as an additional data input the data representing the actual compression ratio in step a); and performing steps b) through f) under additional consideration of the additional data input of the data representing the actual compression ratio. It is possible to change the compression ratio by changing the lengths or positions of various different elements that may determine how far the pistons may travel within the cylinders. Further, no closed loop feedback control is necessary for implementing the control of the variable compression and for considering the variable compression for controlling the fuel temperature prior to injection.

A preferred embodiment may be implemented by heating the fuel in step a) by at least one of i) exclusively electrically within the fuel injector; ii) a combination of exhaust gas preheating upstream of the fuel injector and electric heating within the fuel injector; and iii) a combination of an electric preheating upstream of the fuel injector and electric heating within the fuel injector. In terms of the corresponding structure, at least one of i) an electric heater as the sole heater is provided that heats the fuel in the fuel injector; ii) a combination of exhaust gas preheater located upstream of the fuel injector and an electric heater heating the fuel in the fuel injector; and a combination of electric preheater located upstream of the fuel injector and an electric heater heating the fuel in the fuel injector. Although optional, preheating has the advantage of making the system more responsive since the preheating limits the amount of necessary fuel injector heating. Another advantage of preheating with exhaust gas is that such waste heat can be utilized and therefore the energy consumption for the fuel heating may be reduced.

A preferred embodiment may be implemented by preheating the fuel upstream of the fuel injector to a pre-heated fuel temperature that is below the heated fuel temperature prior to a direct fuel injection; sensing the actual pre-heated fuel temperature; inputting data inputs into the Engine Control Unit (ECU) representing the actual pre-heated fuel temperature; and controlling preheating fuel to the desired pre-heated fuel temperature by the Engine Control Unit (ECU). Depending on the level of responsiveness and effectiveness, such a control of the preheated fuel temperature can be implemented by taking the engine's actual operational conditions into account. Longer delay times for the preheated fuel temperature in comparison to the injector heater can be accepted. Under a number of circumstances, the operational conditions of the engine vary only negligibly, for instance when driving under cruise control conditions at constant speed on a level road. Under such conditions, it is for instance possible to implement the ideal fuel temperature only by the preheater so that the injector heater can rest for as long as these constant engine operational conditions last. Under such conditions, it may also be advantageous that the energy consumption for the fuel heating can be entirely provided by the waste heat from the exhaust gas system.

A preferred embodiment may be implemented by preheating the fuel upstream of the fuel injector to a constant pre-heated fuel temperature that is below the heated fuel temperature prior to a direct fuel injection. Although controlling the preheated temperature is preferred for the aforementioned reasons, a budget solution can be accomplished by preheating the fuel to a constant temperature. Preferably, this temperature is below the desired fuel temperature prior to injection so that the remaining heat to reach this desired fuel temperature is provided by the injector heater. As an alternative, also preheating to a temperature above the desired fuel injection temperature may be accepted within some limits. Although cooling the fuel down from the preheated temperature to a desired fuel injection temperature is theoretically possible as a further alternative, it is more feasible to heat than to cool. Cooling can be accomplished electrically, but also by an air stream of ambient air that typically has a temperature below the temperature of the preheated fuel.

A preferred embodiment may be implemented by performing method step c) based on at least one of a map within the ECU and a mathematical model of a physical system. In terms of the corresponding structure, according to a preferred embodiment ECU stores a mathematical model of a physical system of the internal combustion engine, the mathematical model calculating the data output that is sent through the data output port into the data output line, or in the alternative the ECU stores a map calculating the data output that is sent through the data output port into the data output line. This allows taking basically an unlimited number of variables and operational conditions into account by empirically measuring the influence of the various variables and operational condition data into account and storing these in a map. For the ease of implementing the appropriate calculation within the ECU, it is also possible to generate formula from these empirically determined data, for example by Fourier transformation or Laplace transformation, or by any other way of generating formulas based on the function described by discrete or continuous measuring of the influence of the variables on the outcome.

According to a preferred embodiment the sensor representing the piston position and the sensor sensing the crankshaft rotational speed are combined into one sensor sensing the rotational angle of at least one of the crankshaft and a camshaft of the internal combustion engine. Although more difficult to accomplish, it is also possible to measure the piston position directly.

According to a preferred embodiment the internal combustion engine is further provided with a mechanism for changing the compression ratio and the Engine Control Unit (ECU) comprises a further data input port connected to a data line from a sensor sensing the actual compression ratio. The variable of the compression ratio is calculated by the ECU, meaning that for certain operational conditions of the engine a specific compression ratio is desired, calculated by the ECU, and then the compression ratio is adjusted accordingly. Therefore, it is not absolutely necessary to measure the compression ratio, but is a preferred feature for enhancing the accuracy and providing a closed loop feedback control.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates an example vehicle in which an embodiment of the invention may be employed.

FIG. 2 illustrates an example in which an embodiment of the invention may be employed.

FIG. 3 illustrates an example environment in which a pump system can be implemented according to one embodiment of the present invention.

FIG. 4 illustrates an example pump system according to one embodiment of the present invention.

FIG. 5 illustrates an environment in which embodiments of the invention might be implemented.

FIG. 6 is a block diagram demonstrating the generation of a mixture of fuel vapor and air in the cylinder.

FIG. 7 illustrates a preferred embodiment of the combustion engine and the ECU including the ECU's various inputs and outputs.

FIG. 8 shows a graph illustrating the correlation between the emitted particulate number in correlation to the fuel temperature.

### DETAILED DESCRIPTION OF THE EMBODIMENTS OF THE INVENTION

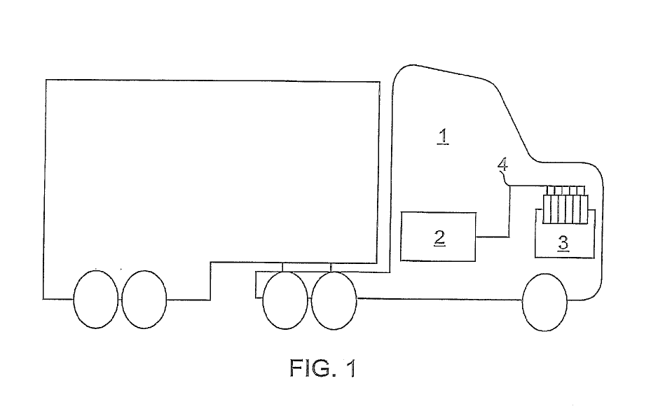

Before describing the invention in detail, it is useful to describe a few example environments with which the invention can be implemented. One such example is that of a vehicle powered by internal combustion engine. FIG. 1 illustrates such a vehicle 1. A fuel supply 2 is disposed within the vehicle and coupled to an engine 3 by a fuel line 4. Fuel from fuel supply 2 is used to power engine 3 to provide motive power to vehicle 1.

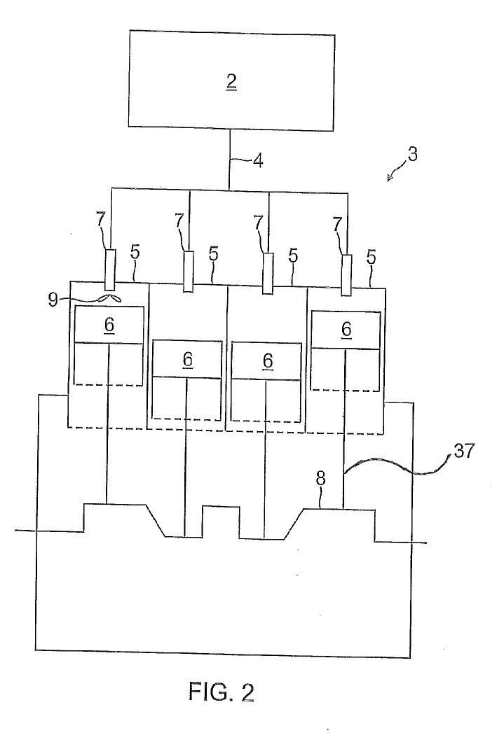

A more particular example is that of an internal combustion engine as illustrated with respect to FIG. 2. Engine 3 comprises a plurality of cylinders 5 having pistons 6 disposed therein. A plurality of fuel injectors 7 is configured to supply fuel to engine 3 and is connected by the fuel line 4 to a fuel source 2. Pistons 6 and cylinders 5 are defining a cylinder volume into which fuel 9 is metered from fuel injector 7. When the fuel 9 is mixed with air and ignited, the piston 6 is displaced, thereby turning crankshaft 8 and providing motive force.

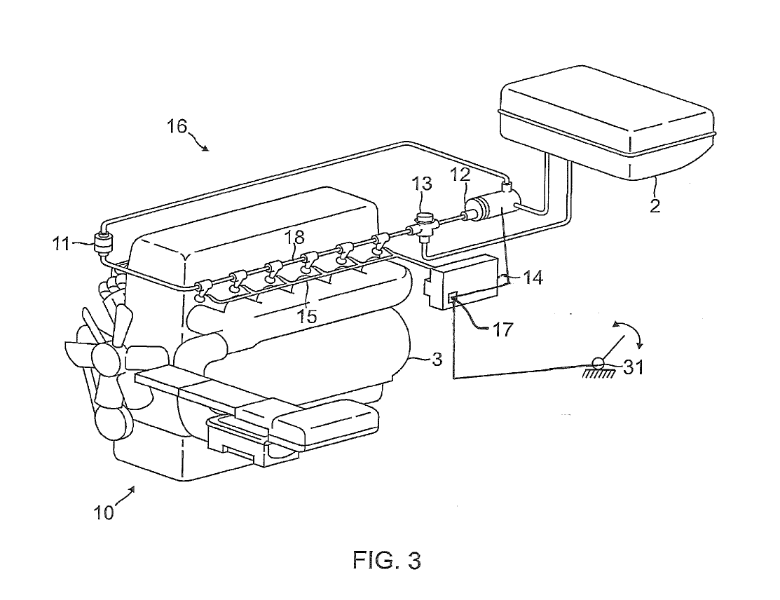

FIG. 3 illustrates an engine system 10 that includes the engine 3, the fuel tank 2, a fuel filter 11, a pump 12, a pressure regulator or accumulator 13, a computer 14, and fuel injectors 15. These components, not including engine 3, comprise a fuel system 16. The computer 14 may include an engine control unit (ECU) 17 that receives an input for a torque demand sensor such as a throttle input from a gas pedal sensor 31 also known as acceleration pedal sensor. The ECU outputs an appropriate fuel pressure and displacement volume request to the motor of pump 12. The ECU at the same time outputs an injector actuation request to a plurality of fuel injectors for the engine.

The pump 12 draws fuel from fuel tank 2 and forces the fuel to pressure regulator 13, which controls the fuel pressure entering into fuel injectors 15 of engine 3. Pressure regulator 13 helps maintain a certain level of pressure at the input of each fuel injector 15. The pressure regulator 13 can be used to release the pressure from the system when desired by the engine control unit of computer 14. One such instance can be when the vehicle is stopped and idling and a lower pressure is demanded.

The fuel filter 11 is typically installed between pump 12 and pressure regulator 13. The fuel filter 11 is responsible for filtering particulates and impurities that may exist in the fuel inside of fuel tank 2. In this way, engine 3 is protected from particulates that could cause damage to engine 3.

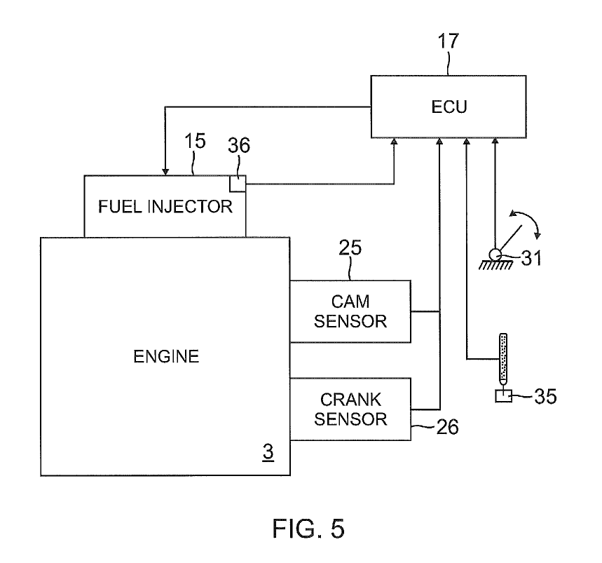

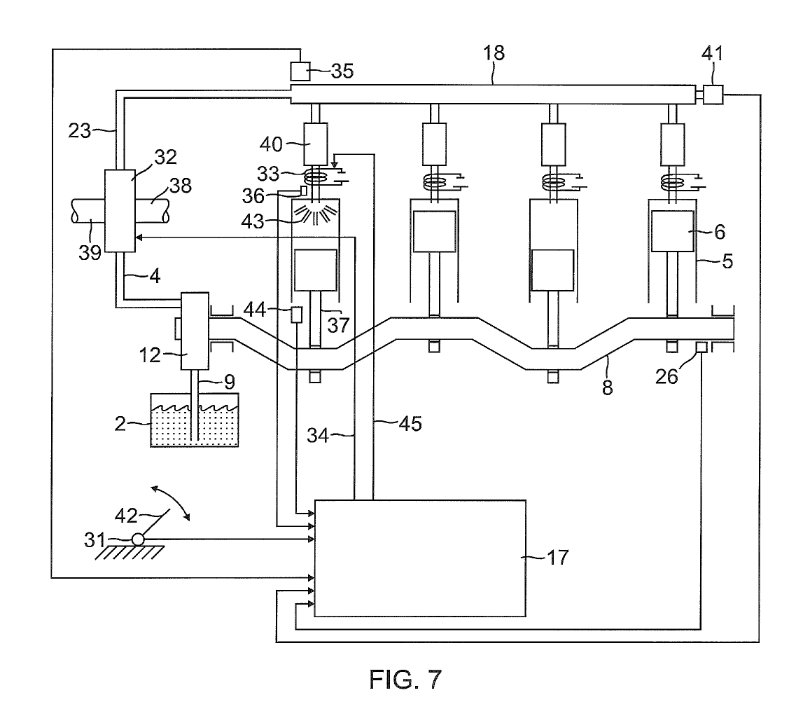

Fuel system 16 can be implemented on various types of engines such as gasoline and diesel engines that may either be designed as spark ignition engines (SI) or compression ignition engines (CI). As shown in FIG. 3, fuel injectors 15 of engine 3 are electronically controlled fuel injectors. In the illustrated embodiment, each of the fuel injectors 15 is an electric solenoid valve fuel injector. In one embodiment, the pump 12 supplies the fuel injectors 15 with heated fuel in order to improve the power and efficiency of the engine 3. To open the solenoid valve and allow fuel to enter engine 3, computer 14 sends a current to a magnetic armature inside within fuel injector 15. Once the armature is charged, an electric field forms and attracts the solenoid to create a passage into the combustion chamber of engine 3. The timing for current discharge is regulated by computer 14. This can be done using feedback from sensors inside of engine 3. One example of such sensors is the engine's crankshaft position sensor 26 as shown in FIGS. 5 and 7. By determining the position of the engine crankshaft, computer 14 can calculate the position of the piston and determine the timing for current discharge.

In fuel system 16, pump 12 and pressure regulator 13 together maintain the fuel pressure inside of a common rail 18, which feeds fuel to each of the fuel injectors 15. As mentioned, the solenoid of fuel injector 15 opens whenever an electric current is discharged. The timing of the electric current discharge is based on the position of the piston or crankshaft of engine 3. Thus, to maintain a generally constant pressure inside of common rail 18 when engine 3 is operating at a high speed, the operating rotational displacement or revolution of fuel pump 12 has to also increase to compensate for the pressure lost as a result of fuel and pressure being bled into each of the fuel injectors 15. In further embodiments, such fuel pressure and engine rotational displacement relationship can be maintained in systems that employ mechanical fuel injectors instead of electronic fuel injectors.

In the context of a vehicle with an internal combustion engine as shown and described in connection with FIGS. 1 through 3 the present invention is directed toward a system and method for controlling fuel temperature depending on at least a combination of the parameters of an engine load, the rotational speed of the engine, and the time of the start of injection. For internal combustion engines with a variable compression ratio, the actual compression ratio is also a parameter to be considered.

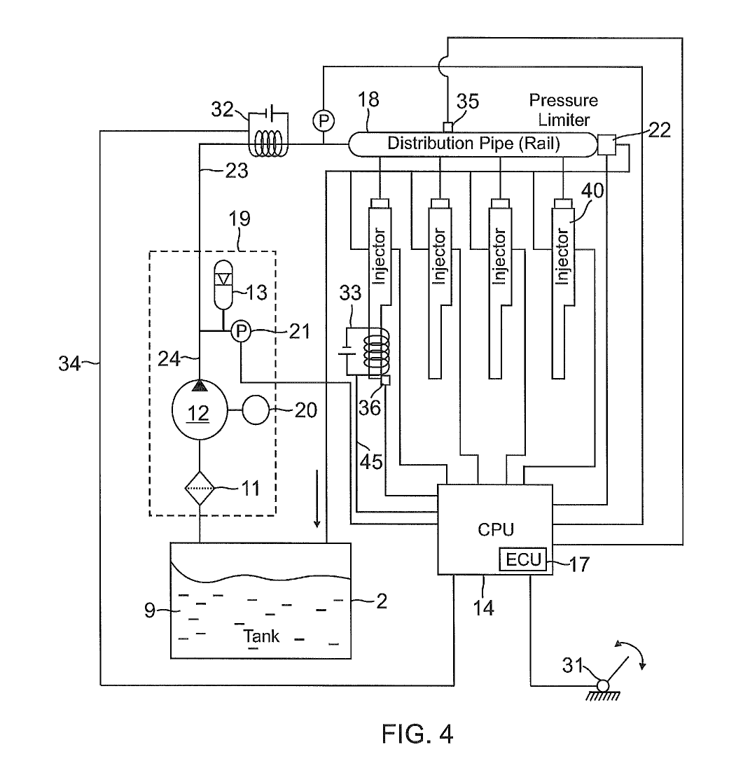

FIG. 4 schematically illustrates an internal combustion engine, specifically the fuel system, some heaters and preheaters, and various sensors. A pump system 19 includes a fuel tank 2, a fuel filter 11, a fuel pump 12, a tachometer 20, pressure regulator or accumulator 13, a pressure sensor 21, a distribution sensor 22, a distribution channel 23, and a computer 14 having an electronic control unit 17. On a high level, fuel pump 12 draws fuel through fuel filter 11 and supplies the fuel to an engine (or other device that requires pressurized fluid) via distribution channel 23. In one embodiment, distribution channel 23 is a common rail 18 configured to supply fuel to a plurality of fuel injectors 15. Other types of distribution channel 23 can also be used in place of common rail 18.

In pump system 19, pump 12 can be a positive displacement pump. Pump 12 is preferably a radial piston pump having a high efficiency with minimal to no leakage of fluid out of the piston pumping chambers. The motor attached to pump 12 rotates a shaft that runs the pump. Each rotation of the motor shaft corresponds to a set volume of fluid pumped by the pump pistons. Tachometer 20 can be configured to sense the rotational displacement of the motor shaft as it relates to volume of fluid pumped and sends the rotational displacement data to computer 14. Tachometer 20 can be a hall sensor having 1-3 poles depending on the needs of the user.

Pressure sensor 21 can be configured to monitor the pressure of the fluid at an outlet 24 of pump 12 and send the pressure data to computer 14. For every rotational displacement value or tachometer count of the motor of pump 12 there is a corresponding fluid pressure value at outlet 24. Computer 14 records and tabularizes the pressure and motor rotational displacement data to create a motor rotational displacement vs. pressure profile for pump 12. The rotational displacement and pressure data can be collected using recording means for storing the data into a memory and/or transmitting the data to a remote data storage system. The pressure data may be analog or digital data.

A preheater 32 is provided in the distribution channel 23. Also other places for providing the preheater are possible, for instance in the common rail 18 supplying the fuel injectors with fuel. The temperature of preheating is typically set to a value that is lower than the fuel injector heater 33. A plurality of fuel injector heaters is typically provided, one for each injector. However, it would also be possible to provide one common injector heater that heats the fuel within the injector. The temperature in the preheater can be either controlled by the ECU or can be held at a constant temperature. One reason for providing a preheater is to make the system more responsive, namely by reducing the amount of heating that needs to be provided by the injector heater 33. For controlling the preheater 32, a preheater data line 34 can be provided connecting the preheater 32 to the ECU 17 or just in general to the computer CPU 14. A preheater temperature sensor 35 can be provided at the common rail or other places like for instance the distribution channel 23. An injector temperature sensor 36 can be provided at or within the injector or close to the exit port for the fuel to be injected. A fuel injector heater data line 45 is provided to receive a control signal by the CPU or ECU in order to control the fuel heating.

FIG. 5 illustrates schematically a data input and a data output for the ECU. Engine 3 may comprise, for example, a gasoline direct injection engine, a diesel engine, or any other fuel injected internal combustion engine. Sensors such as cam sensor 25 or crank sensor 26 or both provide engine operating data to the engine control unit (ECU) 17. The cam sensor 25 is the least ambiguous for determining the next firing cycle while the crank sensor is the least ambiguous for determining the piston position at any given point in time. Additional inputs are coming from the injector temperature sensor 36 and the preheater temperature sensor 35 as well as a torque demand signal coming from the gas pedal sensor 31. For simplicity, not all outputs are shown, for instance going to the preheater 32 and injector heater 33, such as shown in FIG. 4 as the fuel injector heater data line 45 and the preheater data line 34.

The ECU 17 uses this data to determine where on the operating plane the engine is currently operating. As described herein, using this information and predetermined injection pin profiles spanning the engine operating plane, the ECU determines an injection pin profile for the engine's 3 fuel injectors at the operating point. The fuel injector 15 is in connection with the ECU 17, for example via a fuel injector driver, and is caused to inject fuel into the engine 3 according to the injection pin profile determined for the current operating point.

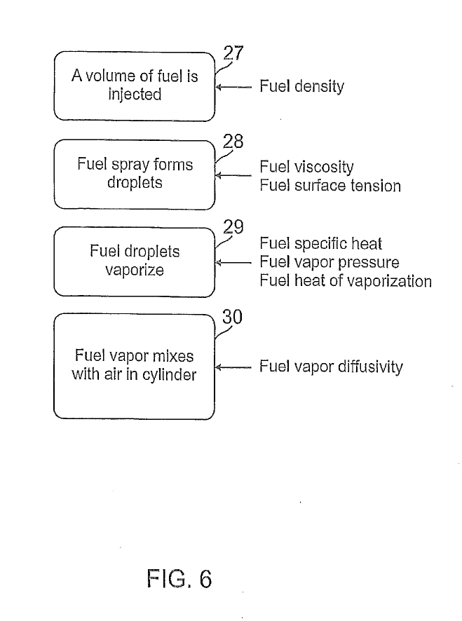

FIG. 6 illustrates the process of fuel injection, droplet formation, vaporization and mixing of vapor in the cylinder. A volume of fuel is injected at step 27 into a combustion volume in a spray. Then, the fuel spray forms into droplets at step 28. The fuel droplets then vaporize at step 29 and the fuel vapor mixes at step 30 with air present in the combustion volume, here a cylinder of an internal combustion engine 3. The fuel finally ignites under the compression heat and possibly injection of an ignition charge or by being ignited by a spark.

FIG. 7 schematically illustrates an internal combustion engine 3 comprising a crankshaft 8 which drives multiple pistons 6 through a connecting rod 37. The compression ratio can be determined by the compression ratio sensor 44 and fed back into the ECU 17. The rotational speed of the crankshaft is measured by the crank sensor 26 that is according to this embodiment designed as a combined sensor that measures simultaneously the rotational angle position of the crankshaft and the rotational speed of the crankshaft. The crankshaft 8 also drives a high pressure fuel pump 12. Pump 12 takes low pressure fuel 9 from the fuel supply 2 such as a fuel tank and compresses it to the high pressure necessary for operation. This high pressure fuel is transported through the distribution channel 23 such as a connecting tube to a fuel preheater 32. In this embodiment, the fuel preheater 32 utilizes waste heat from the exhaust to heat the fuel. Exhaust gas from an exhaust manifold enters the preheater 32 at a preheater inlet 38, transfers heat to the pressurized fuel, and then exits at a preheater outlet 39 the preheater 32. The heating power by the preheater is controlled by the ECU sending a control signal through the preheater data line 34 to the preheater. The heated fuel is transported via the continued distribution channel 23 such as a second tube to the common fuel rail 18. The common fuel rail 18 acts as a distribution manifold to provide fuel to the fuel injectors 40. The pressure of the fuel within the common fuel rail 18 is measured by a common fuel rail pressure sensor 41. Each fuel injector 40 contains a fuel heater 33 and, optionally, a fuel temperature sensor 36 that is connected by a data line to the ECU. Under control of the Engine Control Unit (ECU) 17 sending a control signal through the fuel injector heater data line 45 the fuel injector supplies a fuel spray 43 directly into the cylinder of the internal combustion engine 3, and depending on the timing of injection, specifically into a combustion chamber of the internal combustion engine 3. The torque provided by the engine is controlled by the ECU based on the input of the driver through the accelerator pedal 42 via the gas pedal sensor 31.

In operation, the ECU 17 takes the input from the crank speed sensor 26, the compression ratio sensor 44, the fuel pressure sensor 41, the fuel temperature sensor 36, and the gas pedal sensor 31. Based on these inputs, the ECU 17 calculates the desired fuel temperature and outputs through the fuel injector heater data line 45 a control signal that drives the fuel heater 33 to heat the fuel in the fuel injector to the desired temperature.

As it was already discussed at the outset, the desired fuel temperature is also a function of the start of injection time SOI. However this SOI is calculated based on the operational conditions of the engine as an ideal start of injection time. Although it is possible to sense this start of injection time and provide as a parameter by a closed loop feedback control to the ECU, since the ECU controls that SOI, it may as well be used as directly calculated by the ECU making an SOI sensor redundant.

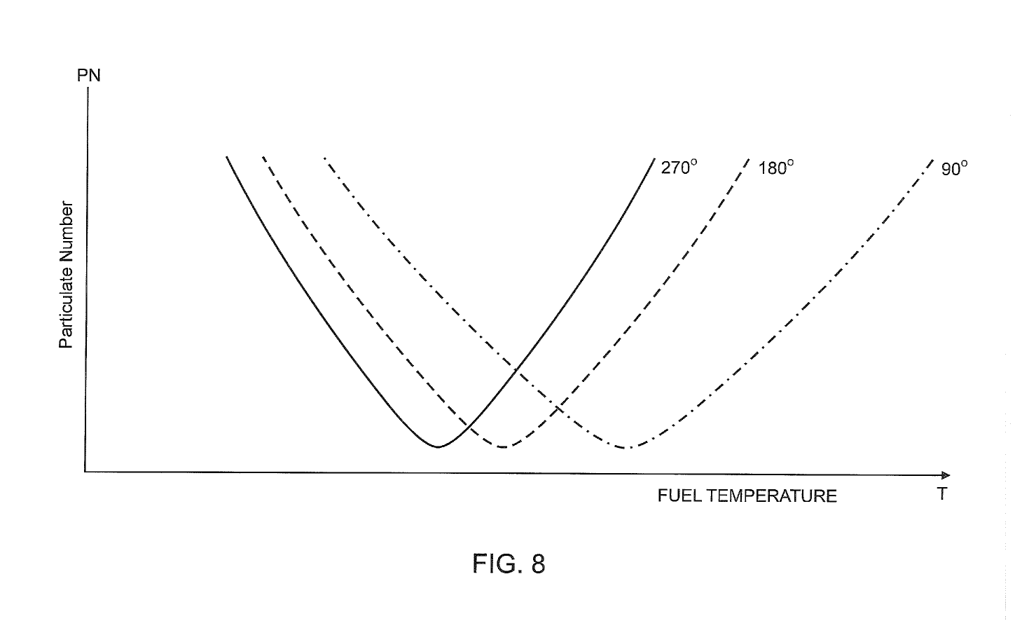

FIG. 8 represents a characteristic curve for the amounts of particulate emissions generated versus the temperature of the fuel. Each line on the graph represents a unique Start of Injection (SOI) timing. The lines are labeled in degrees of rotation before top dead center of the compression stroke. A similar curve will be developed for unique values of demanded torque and for unique values of Compression Ratio (CR). The ECU 17 shown in FIG. 1 will use these characteristic curves to determine the correct fuel temperature for each operating state of the engine.

### LIST OF REFERENCE NUMERALS

1 vehicle
2 fuel supply
3 engine
4 fuel line
5 cylinders
6 pistons
7 fuel injector
8 crankshaft
9 fuel
10 engine system
11 fuel filter
12 fuel pump
13 pressure regulator
14 computer
15 fuel injector
16 fuel system
17 engine control unit
18 common fuel rail
19 pump system
20 tachometer
21 pressure sensor
22 distribution sensor
23 distribution channel
24 outlet
25 cam sensor
26 crank sensor
27 volume injection step
28 droplet forming step
29 vaporizing step
30 fuel vapor mixing step
31 pedal sensor
32 preheater
33 injector heater
34 preheater data line
35 preheater temperature sensor
36 injector temperature sensor
37 connecting rod
38 preheater inlet
39 preheater outlet
40 fuel injector
41 common fuel rail pressure sensor
42 accelerator pedal
43 fuel spray
44 compression ratio sensor
45 fuel injector heater data line

What is claimed is:

1. A method of direct fuel injection of fuel into a cylinder of an internal combustion engine, the method comprising:
a) inputting at least data inputs representing a piston position, a rotational speed of the internal combustion engine, and a torque demand into an Engine Control Unit (ECU);
b) calculating in the Engine Control Unit (ECU) a calculated start of injection (SOI) for the direct fuel injection that is next based on the data inputs;
c) calculating based on the data inputs and the calculated start of injection (SOI) a desired fuel temperature prior to the direct fuel injection that is next;
d) heating fuel with a system delay not to exceed 5 seconds to the desired heated fuel temperature prior to a direct fuel injection;
e) injecting the fuel heated in step d);
f) repeating steps a) to e) for subsequent direct fuel injections.

2. The method of claim 1, further comprising sensing the fuel temperature of the fuel heated in step d) and inputting data representing the fuel temperature into the Engine Control Unit (ECU) for providing a closed loop control of that fuel temperature.

3. The method of claim 1, further comprising sensing the piston position and the rotational speed of the internal combustion engine by a sensor provided at at least one of a crankshaft and a camshaft of the internal combustion engine.

4. The method of claim 1, further comprising calculating in the Engine Control Unit (ECU) for an internal combustion engine having a variable compression ratio based on the data inputs in step a) a desired compression ratio for the direct fuel injection that is next; calculating based on the data inputs, the start of injection (SOI) calculated in step b), and the calculated compression ratio a desired fuel temperature prior to the direct fuel injection that is next; and commencing with steps d) to f) based on that desired fuel temperature.

5. The method of claim 4, further comprising adjusting the variable compression ration by a compression ratio adjusting mechanism; sensing an actual compression ratio and inputting data representing the actual compression ratio into the Engine Control Unit (ECU) for providing a closed loop control of that compression ratio and consequently of the actual compression ratio; inputting as an additional data input the data representing the actual compression ratio in step a); and performing steps b) through f) under additional consideration of the additional data input of the data representing the actual compression ratio.

6. The method of claim 1, further comprising heating the fuel in step a) by at least one of i) exclusively electrically within the fuel injector; ii) a combination of exhaust gas pre-heating upstream of the fuel injector and electric heating within the fuel injector; and iii) a combination of an electric preheating upstream of the fuel injector and electric heating within the fuel injector.

7. The method of claim 1, further comprising preheating the fuel upstream of the fuel injector to a pre-heated fuel temperature that is below the heated fuel temperature prior to a direct fuel injection; sensing the actual pre-heated fuel temperature; inputting data inputs into the Engine Control Unit (ECU) representing the actual pre-heated fuel temperature; and controlling preheating fuel to the desired pre-heated fuel temperature by the Engine Control Unit (ECU).

8. The method of claim 1, further comprising preheating the fuel upstream of the fuel injector to a constant pre-heated fuel temperature that is below the heated fuel temperature prior to a direct fuel injection.

9. The method of claim 1, further comprising performing method step c) based on at least one of a map within the ECU and a mathematical model of a physical system.

10. An internal combustion engine comprising:
at least one cylinder-piston combination with a piston performing a linear movement within the cylinder, the cylinder-piston combination defining a cylinder volume that is connected to a fuel injector;
a crankshaft;
a fuel heater heating fuel in the injector;
a connecting rod connecting the piston to the crankshaft;
a sensor representing a piston position;
a sensor representing the rotational speed of the crankshaft;
a fuel injector temperature sensor sensing the temperature of fuel to be injected;
a torque demand sensor;
an Engine Control Unit (ECU) comprising at least data input ports for data lines from the sensor representing a piston position; the sensor representing the rotational speed of the crankshaft, the fuel injector temperature, and the torque demand sensor and having at least one data output port connecting to a data line to the fuel heater, wherein the ECU calculates the data output through the data output line at least based on data input from the data input ports.

11. The internal combustion engine of claim 1, wherein the sensor representing the piston position and the sensor representing the rotational speed of the crankshaft are combined into one sensor sensing the rotational angle of at least one of the crankshaft and a camshaft of the internal combustion engine.

12. The internal combustion engine of claim 10, wherein the internal combustion engine is further provided with a mechanism for changing the compression ratio and the Engine Control Unit (ECU) comprises a further data input port connected to a data line from a sensor sensing the actual compression ratio.

13. The internal combustion engine of claim 10, further comprising at least one of i) an electric heater as the sole heater that heats the fuel in the fuel injector; ii) a combination of exhaust gas preheater located upstream of the fuel injector and an electric heater heating the fuel in the fuel injector; and a combination of electric preheater located upstream of the fuel injector and an electric heater heating the fuel in the fuel injector.

14. The internal combustion engine of claim 10, wherein the ECU stores a map calculating the data output that is sent through the data output port into the data output line.

15. The internal combustion engine of claim 10, wherein ECU stores a mathematical model of a physical system of the internal combustion engine, the mathematical model calculating the data output that is sent through the data output port into the data output line.
